(19) United States
(12) Patent Application Publication
(10) Pub. No.: US 2011/0109029 A1
(43) Pub. Date: May 12, 2011

(54) Object Holding Apparatus

(75) Inventors: Shogo Takeda, Findlay, OH (US); Toshikazu Yamate, Findlay, OH (US)

(73) Assignee: Molten Corporation, Hiroshima (JP)

(21) Appl. No.: 12/615,947

(22) Filed: Nov. 10, 2009

(51) Int. Cl. B25B 11/00; B24C 5/00

(52) U.S. Cl. 269/8; 451/29; 451/460

(57) ABSTRACT

An object holding apparatus for holding an object, a portion of which is supposed to be surface treated, the object holding apparatus including: a body to which the object is fixed; a mask for covering a non-treatment portion of the object; and a magnetic fixing member for bringing the mask into close contact with the object by magnetic force. The body includes an engagement member for engaging with the object, thereby positioning the object.

### BACKGROUND

The present disclosure relates to an object holding apparatus for holding an object, for example, in a process of coating the object.

Conventionally, partial coating, sandblasting, etc., of an object (hereinafter referred to as surface treatment) have been performed. In such a process, a portion of the object where the surface treatment is not required has to be covered with a mask. For example, Japanese Patent Publication No. H05-329773 discloses a method for fixing the mask to the object by magnetic force.

The mask disclosed by this publication is made of a magnetic material. A body of a holder for holding the object has an electromagnet attached thereto. When the magnetic force is generated by the electromagnet with a rear surface of the object kept in contact with the electromagnet, the mask is sucked by the magnetic force, and is brought into close contact with the object. Thus, a portion of the object is covered with the mask.

However, the object generally has dimensional error within a tolerance. When this object is fixed to the body of the holder, the fixed object may be misaligned from the right position. The misalignment of the fixed object results in misalignment of the electromagnet attached to the body of the holder relative to the object. Therefore, the mask sucked by the electromagnet is also misaligned relative to the object, and the portion of the object supposed to be covered with the mask is exposed. This may cause defective products.

In view of the above-described disadvantage, a technique disclosed in this specification is intended to allow for positioning of the object relative to the body of the holder in fixing the mask by the magnetic force, thereby precisely fixing the mask to the right position, and reducing the number of defective products.

### SUMMARY

According to one example implementation, an object holding apparatus for holding an object, a portion of which is supposed to be surface treated, is disclosed as a solution to the above-described disadvantage. The object holding apparatus includes: a body to which the object is fixed; a mask for covering a non-treatment portion of the object; and a magnetic fixing member for bringing the mask into close contact with the object by magnetic force, wherein the body includes an engagement member for engaging with the object, thereby positioning the object.

According to the example implementation, the object is positioned by the engagement with the engagement member of the body. This can fix the object to the right position relative to the body. Further, since the magnetic fixing member can fix the mask, the mask can be fixed to the right position relative to the object. Thus, the non-treatment portion of the object can reliably be covered with the mask, thereby reducing the number of defective products.

The engagement member preferably includes an insertion part formed to be inserted in a portion of the object.

With this configuration, insertion of the insertion part in the portion of the object allows for easy positioning of the object, thereby improving workability.

The body preferably includes a biasing member for biasing the insertion part in a direction in which the insertion part is inserted in the portion of the object.

With this configuration, the insertion part is less likely to detach from the object, thereby allowing for reliable positioning of the object.

The engagement member may be configured to sandwich a portion of the object.

With this configuration, the possibility of the misalignment of the object can be reduced by simple operation.

The magnetic fixing member may include a magnet detachably attached to the mask, and a magnetic material fixed to the body, and the mask may be fixed by exerting magnetic force of the magnet attached to the mask on the magnetic material of the body.

With this configuration, the magnet can be removed from the mask for reuse in the case of break and disposal of the mask.

### BRIEF DESCRIPTION OF THE DRAWINGS

FIG. 1 is a side view illustrating an object holding apparatus of a first embodiment.

FIG. 2 is a perspective front view of the object.

FIG. 3 is a perspective back view of the object.

FIG. 4 is a cross-sectional view taken along the line IV-IV of FIG. 1 illustrating the object in a held state.

FIG. 5 is a perspective view illustrating an enlargement of a box-shaped part of the object and its vicinity.

FIG. 6 is a perspective view illustrating an enlargement of a protrusion of the object and its vicinity.

FIG. 7 is a view illustrating an object fixing member as viewed in the direction of a rotating shaft.

FIG. 8 is a view illustrating the object fixing member as viewed from the top of the object holding plate.

FIG. 9 is a view illustrating the object holding plate of the object fixing member and its vicinity.

FIG. 10 is a view corresponding to FIG. 4 illustrating a mask in a fixed state.

FIG. 11 is a cross-sectional view taken along the line XI-XI of FIG. 10.

FIG. 12 is a view corresponding to FIG. 5 illustrating a first modified example of the first embodiment.

FIG. 13 is a view corresponding to FIG. 5 illustrating a second modified example of the first embodiment.

FIG. 14 is a view corresponding to FIG. 1 illustrating a second embodiment.

FIG. 15 is a view corresponding to FIG. 7 illustrating the second embodiment.

FIG. 16 is a view corresponding to FIG. 4 illustrating the second embodiment.

FIG. 17 is a view corresponding to FIG. 8 illustrating the second embodiment.

FIG. 18 is a view corresponding to FIG. 9 illustrating the second embodiment.

FIG. 19 is a view corresponding to FIG. 10 illustrating the second embodiment.

### DETAILED DESCRIPTION

Embodiments of the present disclosure will be described hereinafter with reference to the drawings. The following preferred embodiments are described only for the purpose of illustration, and are not intended to limit the scope, applications and use of the disclosed technique.

### First Embodiment

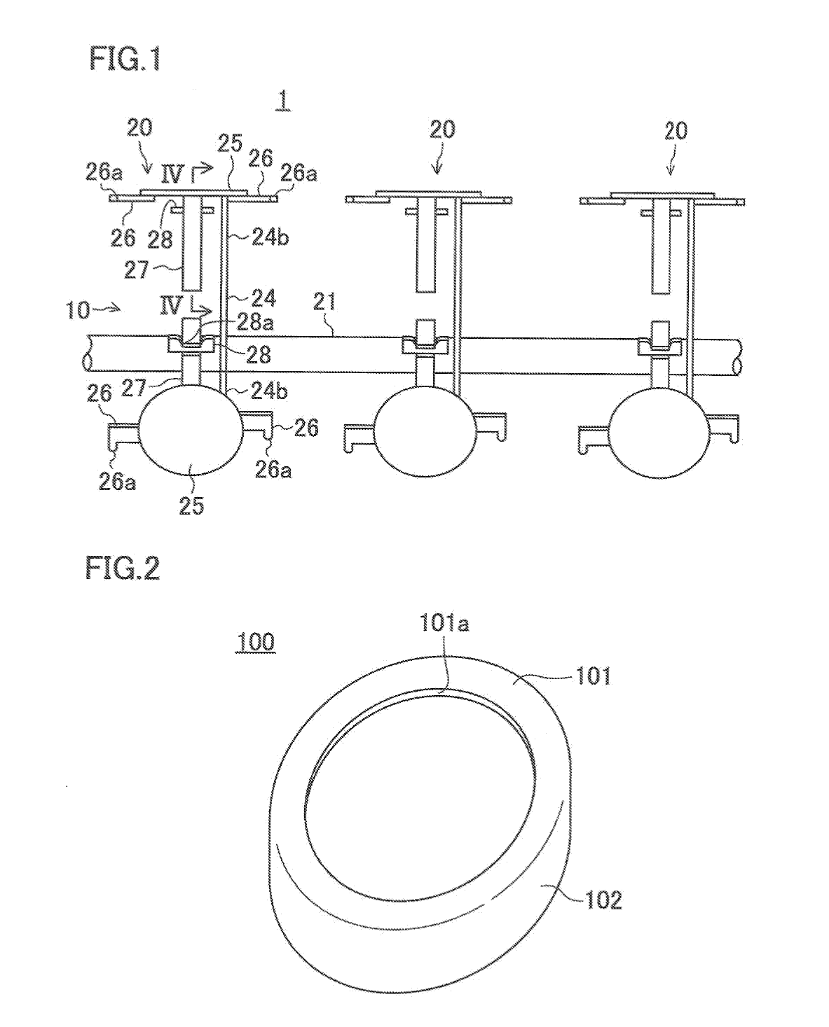

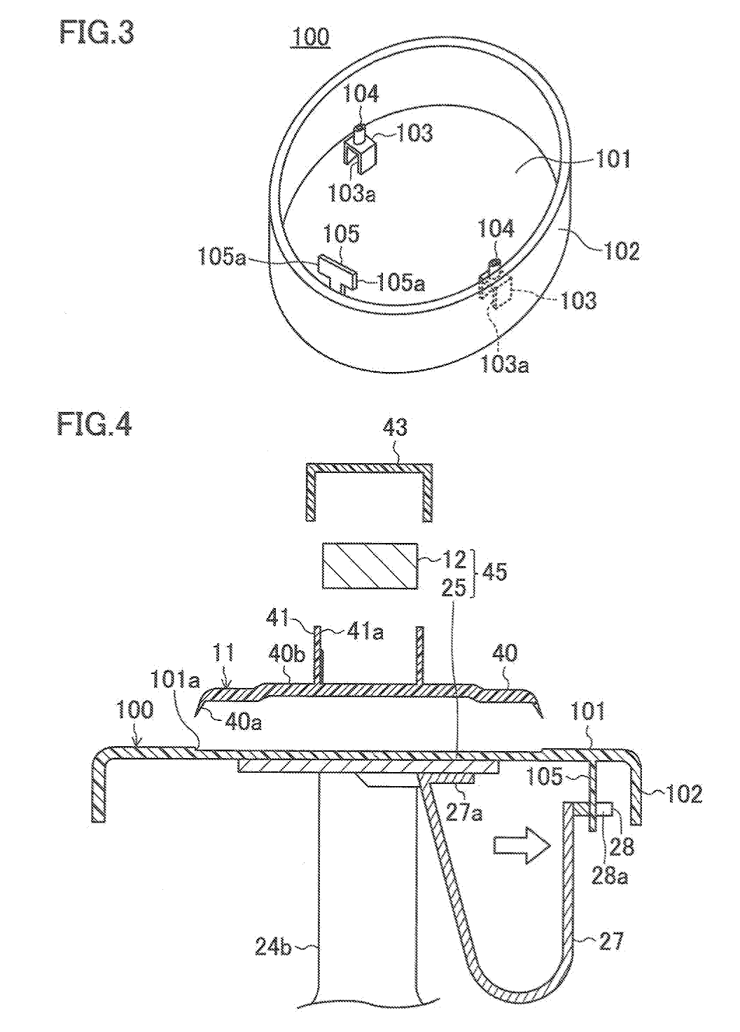

FIG. 1 shows an object holding apparatus 1 of the first embodiment. The object holding apparatus 1 is used for coating operation, which is one of surface treatments, of an object 100 shown in FIGS. 2 and 3.

Before the description of the structure of the object holding apparatus 1, the structure of the object 100 will be described first. The object 100 is a resin product for vehicles. As shown in FIG. 2, the object 100 includes a round plate 101, and a circumferential wall 102 extending from the whole circumference of the round plate 101 toward a rear side of the round plate 101. The round plate 101 is integrated with the circumferential wall 102. A substantially round recess 101a is formed in a front surface of the round plate 101. An inner surface of the recess 101a is a non-treatment portion where the coating is not performed. The coating is performed on a portion of the round plate 101 except for the recess 101a, and the surface of the circumferential wall 102.

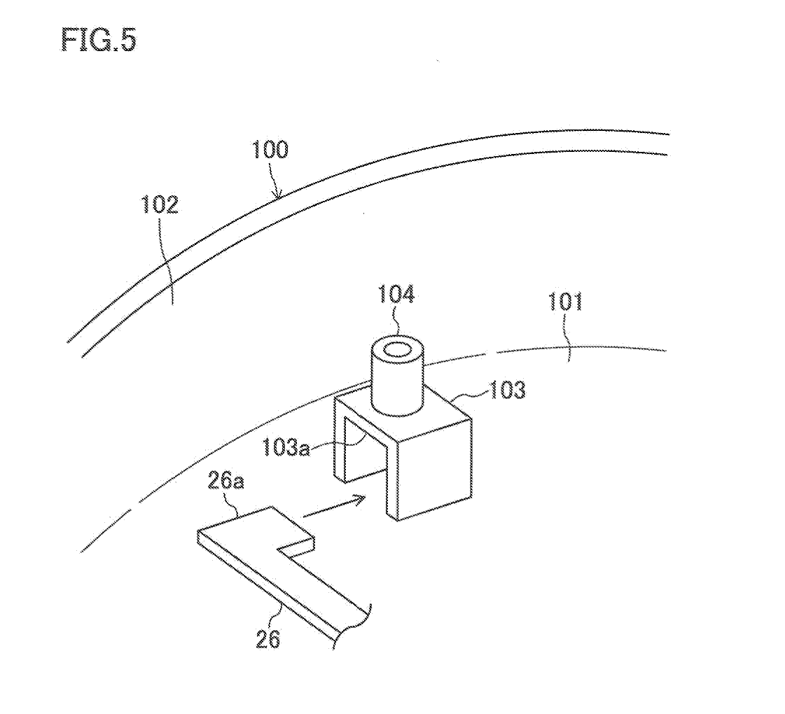

As shown in FIG. 3, two box-shaped parts 103 are formed on a rear surface of the round plate 101. The box-shaped parts 103 are separated from each other by 180° in the circumferential direction of the round plate 101. As shown in FIG. 5, each of the box-shaped parts 103 is in the shape of a hollow cube, and one of side surfaces facing the circumferential direction of the round plate 101 is opened to form an opening 103a communicating with the inside of the hollow cube. The box-shaped part 103 is provided with a boss 104 in which a screw (not shown) for fastening the object 100 to a vehicle is screwed.

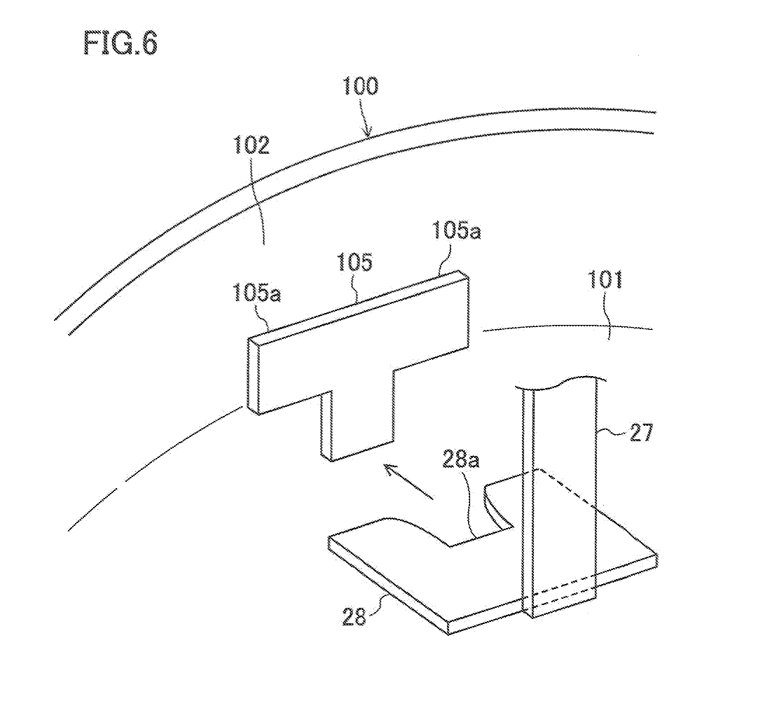

As shown in FIG. 3, a protrusion 105 protruding toward the rear side of the round plate 101 is formed on the rear surface of the round plate 101 near the boundary with the circumferential wall 102. The protrusion 105 is located halfway between the box-shaped parts 103 in the circumferential direction of the round plate 101. The protrusion 105 extends substantially vertically from the round plate 101. As shown in FIG. 6, a pair of flat extensions 105a extend from a distal end of the protrusion 105 in opposite lateral directions of the protrusion 105.

The structure of the object holding apparatus 1 will be described below. The object holding apparatus 1 is configured to be able to rotate a plurality of the objects 100 for uniform coating, with the objects 100 being securely held.

The object holding apparatus 1 includes a body 10 (see FIG. 1) to which the object 100 is fixed, a mask 11 (see FIG. 4) for covering the non-treatment portion of the object 100, and a magnet 12 (see FIG. 4) for bringing the mask 11 into close contact with the object 100 by magnetic force.

As shown in FIG. 1, the body 10 includes a plurality of object fixing members 20, and a rotating shaft 21 to which the object fixing members 20 are attached. The rotating shaft 21 receives rotary force output and transmitted from a drive (not shown).

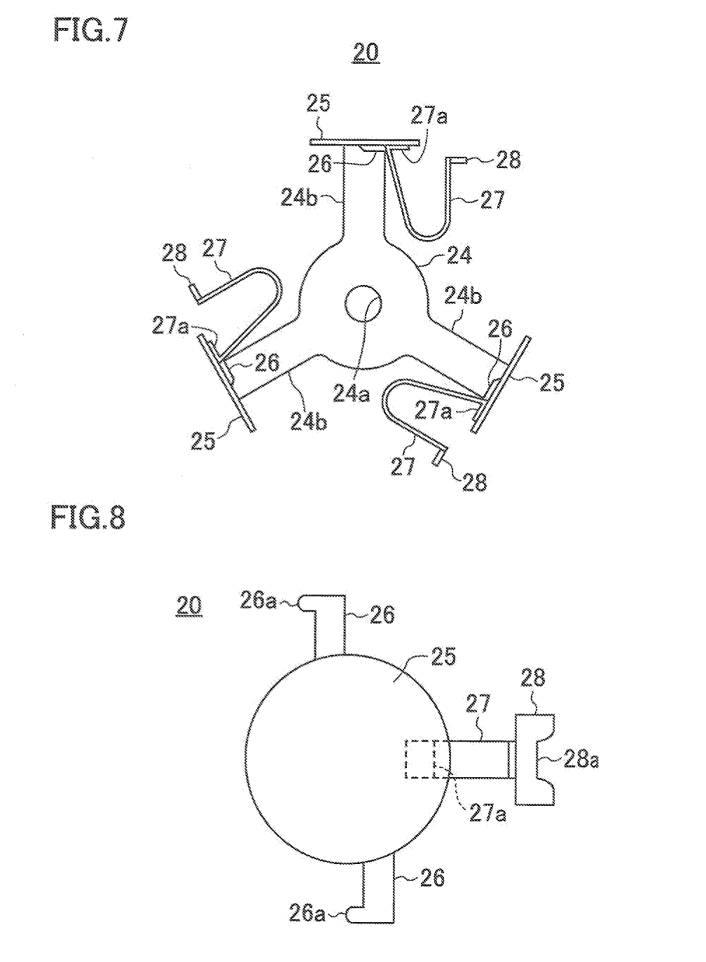

Each of the object fixing members 20 includes a plate 24 extending in the radial direction of the rotating shaft 21, and object holding plates 25 fixed to the plate 24 as shown in FIG. 7. The object fixing member 20 further includes a pair of engagement plates 26 fixed to each of the object holding plates 25, and a flat spring 27 fixed to each of the object holding plates 25 as shown in FIG. 8. As shown in FIG. 7, the plate 24 has a through hole 24a formed in the center thereof for inserting the rotating shaft 21 therein. The plate 24 includes three flat protrusions 24b radially protruding from the center of the plate 24. The flat protrusions 24b are arranged at regular intervals.

As shown in FIG. 8, each of the object holding plates 25 is comprised of a round steel plate (made of a magnetic material). As shown in FIG. 4, the object holding plate 25 is configured to contact the rear surface of the round plate 101 of the object 100. A diameter of the object holding plate 25 is smaller than a diameter of the recess 101a of the object 100. As shown in FIG. 7, the object holding plate 25 is fixed to a distal end of each of the flat protrusions 24b of the plate 24, with the object holding plate 25 extending in the tangential direction of the rotating shaft 21.

The engagement plates 26 are engagement members engaging with the box-shaped parts 103 of the object 100, respectively. As shown in FIG. 8, the engagement plates 26 are arranged to be separated from each other by 180° in the circumferential direction of the object holding plate 25. A proximal end of each of the engagement plates 26 is fixed to the object holding plate 25, and a distal end protrudes radially outward from the peripheral edge of the object holding plate 25. At the distal end of each of the engagement plates 26, an insertion part 26a is formed to protrude in the tangential direction of the object holding plate 25. The insertion part 26a is supposed to be inserted in the opening 103a of the corresponding box-shaped part 103 of the object 100. The insertion parts 26a of the two engagement plates 26 protrude in the same direction so as to correspond to the openings 103a of the two box-shaped parts 103 of the object 100. With the insertion parts 26a of the engagement plates 26 inserted in the box-shaped parts 103, respectively, the engagement plates 26 engage with a portion of the object 100, i.e., the box-shaped parts 103.

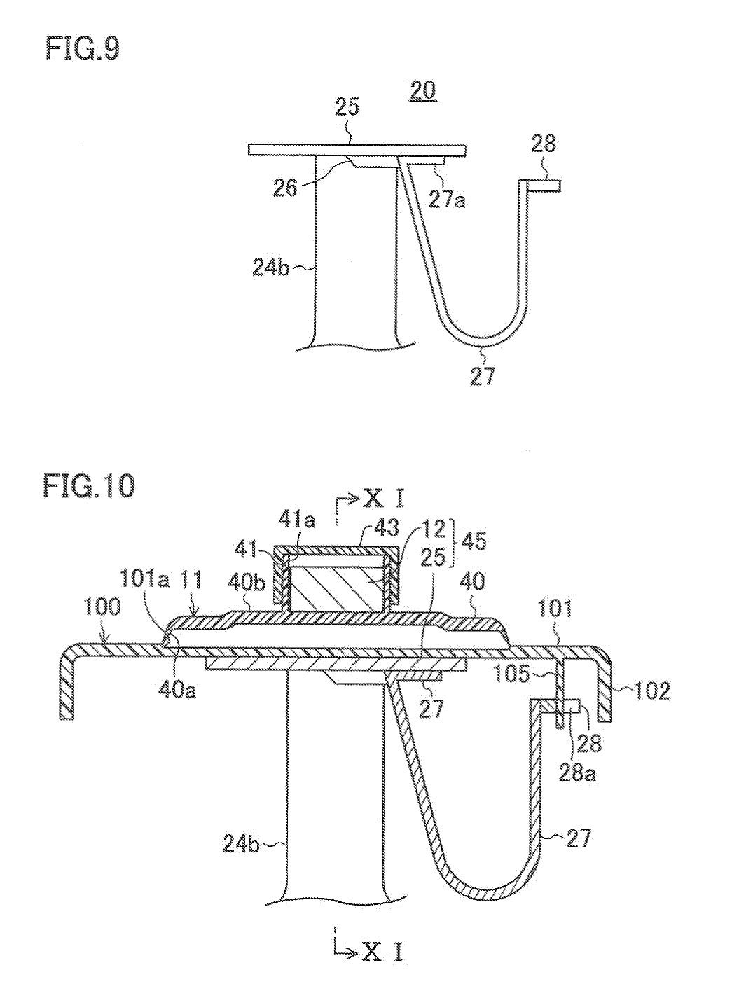

As shown in FIG. 7, the flat spring 27 is formed by bending a spring steel strip substantially in the shape of letter U. An end of the flat spring 27 is configured as a fixed portion 27a fixed to the object holding plate 25. The fixed portion 27a is formed by bending the end of the flat spring 27 to extend along the object holding plate 25. As shown in FIG. 8, the fixed portion 27a is positioned halfway between the engagement plates 26. As shown in FIG. 9, the flat spring 27 extends from the object holding plate 25 to the proximal end of the flat protrusion 24b, and is curved to extend toward the distal end of the flat protrusion 24b. The distal end of the flat spring 27 is separated radially outward from the peripheral edge of the object holding plate 25.

An engagement piece (or an engagement member) 28 is provided at the distal end of the flat spring 27. The engagement piece 28 extends in a direction orthogonal to the distal end of the flat spring 27. As shown in FIG. 8, the engagement piece 28 is wider than the distal end of the flat spring 27, and protrudes from the distal end of the flat spring 27 in opposite lateral directions. The engagement piece 28 is provided with a cut 28a formed in the lateral center thereof. The cut 28a is opened in the direction opposite the fixed portion 27a of the flat spring 27. As shown in FIG. 6, the width of the cut 28a is designed to gradually increase toward its opening end.

As shown in FIG. 4, the protrusion 105 of the object 100 fits in the cut 28a. In this state, the engagement piece 28 engages with the protrusion 105 which is a portion of the object 100. With the engagement piece 28 engaging with the protrusion 105, the flat spring 27 biases the object 100 in the direction indicated by a solid arrow shown in FIG. 4. This prevents the insertion parts 26a from detaching from the box-shaped parts 103.

Referring to FIG. 4, the structure of the mask 11 and the electromagnet 12 will be described. The mask 11 is a resin mold product, and is shaped to cover the recess 101a of the object 100. The mask 11 includes a body 40 in the shape of a round plate having substantially the same size as the recess 101a of the object 100, and a magnet housing 41 for containing the magnet 12. The body 40 is integrated with the magnet housing 41.

The body 40 includes a lip 40a extending from the peripheral edge of the body 40 toward the peripheral edge of the recess 101a, and a bulge 40b bulging from the center of the body 40 in the direction opposite the extending direction of the lip 40a.

The magnet housing 41 is arranged in the center of the bulge 40b. The magnet housing 41 is in the shape of a cylinder protruding in the direction opposite the extending direction of the lip 40a. An axial end of the magnet housing 41 is configured as a housing opening 41a. The magnet 12 contained in the magnet housing 41 is in the shape of a cylindrical column, and is removable from the magnet housing 41. The inner dimension of the magnet housing 41 is determined to correspond to the dimension of the magnet 12. This can prevent rattling of the magnet 12 contained in the magnet housing 41.

The magnet 12 exerts magnetic force on the object holding plate 25 of the object holding apparatus 1. The intensity of the magnetic force is determined to such a degree that the object 100 is not misaligned with the object holding plate 25, and is firmly fixed even when the object 100 is turned upside down. The magnet 12 and the object holding plate 25 constitute a magnetic fixing member 45 according to the present disclosure.

A cap 43 for covering the housing opening 41a can be attached to the magnet housing 41. The cap 43 is configured to fit onto the outer surface of the magnet housing 41, and is detachable from the magnet housing 41.

Coating of the object 100 using the above-described object holding apparatus 1 will be described. First, as shown in FIG. 4, the object 100 is held on the object holding apparatus 1. In this case, as indicated by an arrow in FIG. 5, the insertion parts 26a of the engagement plates 26 of the object holding apparatus 1 are moved to be inserted in the box-shaped parts 103, respectively. Thus, the engagement plates 26 engage with the object 100. Further, the protrusion 105 of the object 100 is inserted in the cut 28a of the engagement piece 28 of the flat spring 27 of the object holding apparatus 1, thereby engaging the engagement piece 28 with the object 100. In this way, the object 100 is positioned relative to the object holding plate 25.

Due to the engagement of the engagement piece 28 with the object 100, spring force of the flat spring 27 is exerted on the protrusion 105 in the radially outward direction of the object 100 (the direction indicated by the solid arrow in FIG. 4), i.e., in the direction in which the insertion parts 26a of the engagement plates 26 are inserted in the box-shaped parts 103. This prevents the insertion parts 26a from detaching from the box-shaped parts 103, thereby stabilizing the object 100. Moreover, the position of the object 100 relative to the object holding plate 25 is determined at three locations separated in the circumferential direction of the object 100. This also contributes to the stabilization of the object 100.

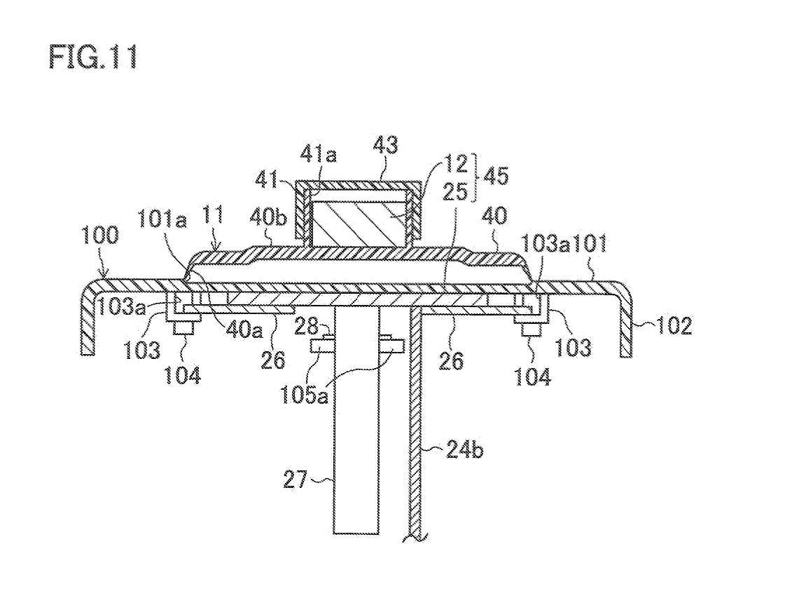

Then, the mask 11 is fixed to the object 100. First, as shown in FIGS. 10 and 11, the magnet 12 is contained in the magnet housing 41, and the housing opening 41a is covered with the cap 43.

The mask 11 is placed on the surface of the object 100 with the lip 40a of the mask 11 aligned with the peripheral edge of the recess 101a of the object 100. Thus, the magnetic force of the magnet 12 is exerted on the object holding plate 25, thereby fixing the mask 11 to the object 100. The magnetic force pushes the object 100 onto the object holding plate 25, thereby preventing misalignment of the object 100.

In the foregoing manner, the object 100 is held on the object holding apparatus 1, and the mask 11 is fixed to the object 100. Thereafter, the coating of the object 100 is performed while rotating the rotating shaft 21. In this case, the object 100 is positioned relative to the body 10, and the mask 11 is fixed to the object 100 at the right position. Therefore, the mask 11 can cover the intended portion of the object 100, and adhesion of paint to the non-coating portion (the non-treatment portion) is less likely to occur.

According to the first embodiment described above, the object 100 is positioned relative to the body 10 in fixing the mask 11 by the magnetic force. Therefore, the mask 11 can precisely be fixed at the right position, thereby reducing the number of defective products.

The positioning of the object 100 is easily performed by inserting the insertion parts 26a into the box-shaped parts 103 of the object 100. This improves workability.

The flat spring 27 biases the insertion parts 26a of the engagement plates 26 in the direction in which the insertion parts 26a are inserted in the box-shaped parts 103 of the object 100. Therefore, the insertion parts 26a are less likely to detach from the object 100, thereby reliably positioning the object 100.

The magnet 12 is detachably attached to the mask 11. Therefore, the magnet 12 can be removed from the mask 11 for reuse, for example, in the case of break and disposal of the mask 11.

The object holding apparatus 1 can hold a large number of the objects 100. This can reduce the amount of the paint used, and time required for the coating, thereby drastically improving the efficiency of the coating operation.

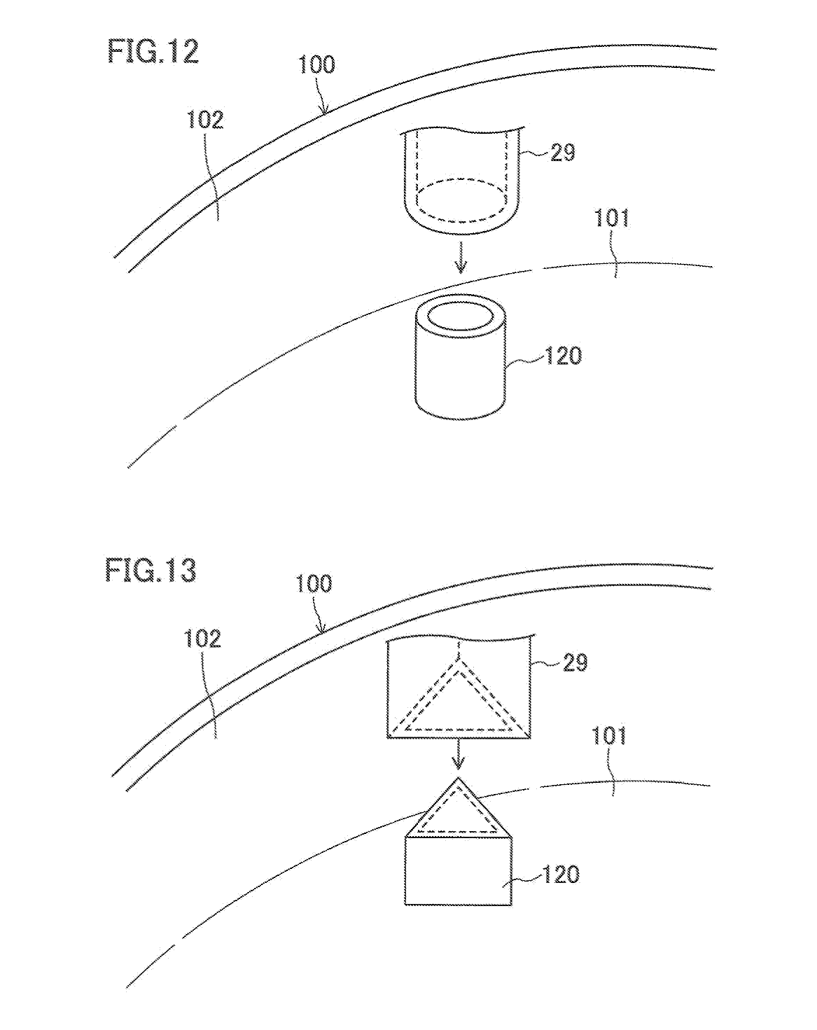

According to a first modified example shown in FIG. 12, the object 100 may be provided with a cylindrical part 120 having a round cross section, and the body 10 may be provided with a cylindrical fitting member 29 fitted on the outer surface of the cylindrical part 120. The cylindrical part 120 protrudes from the rear surface of the round plate 101 in the direction orthogonal to the rear surface. The fitting member 29 is fixed to the engagement plate 26 coaxially with the cylindrical part 120. An inner diameter of the fitting member 29 is slightly smaller than an outer diameter of the cylindrical part 120. This prevents easy detachment of the fitting member 29 from the cylindrical part 120. The fitting between the cylindrical part 120 and the fitting member 29 allows for engagement between the object 100 and the engagement plate 26. In providing the object 100 with the cylindrical part 120, a molding die for forming the object 100 can be provided without a sliding die, thereby reducing the cost of the molding die. Preferably, a plurality of cylindrical parts 120 and fitting members 29 are provided.

According to a second modified example shown in FIG. 13, the cylindrical part 120 of the object 100 may have a triangular cross section. In this case, the fitting member 29 also has a triangular cross section to correspond to the cross sectional shape of the cylindrical part 120. The cylindrical part 120 and the fitting member 29 may have a polygonal cross section, such as a square cross section.

In the examples shown in FIGS. 12 and 13, the hollow cylindrical part 120 is provided. However, the disclosure is not limited thereto, and the hollow cylindrical part 120 may be replaced with a solid cylindrical column, a triangular prism, etc.

### Second Embodiment

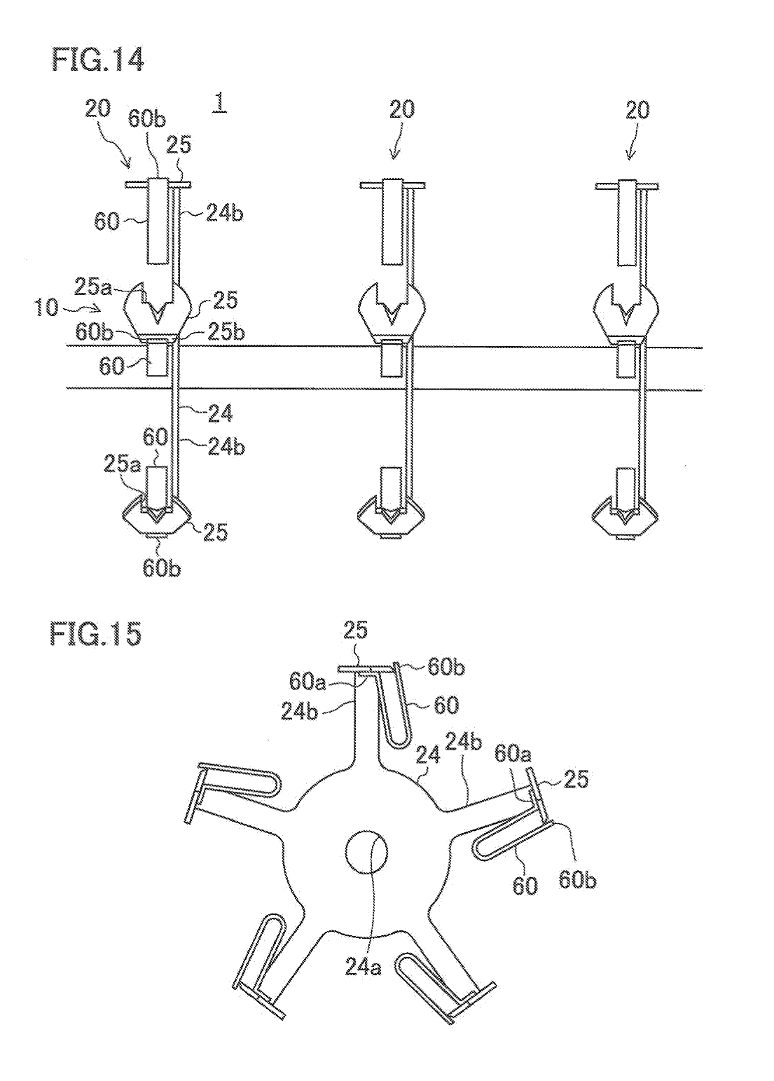

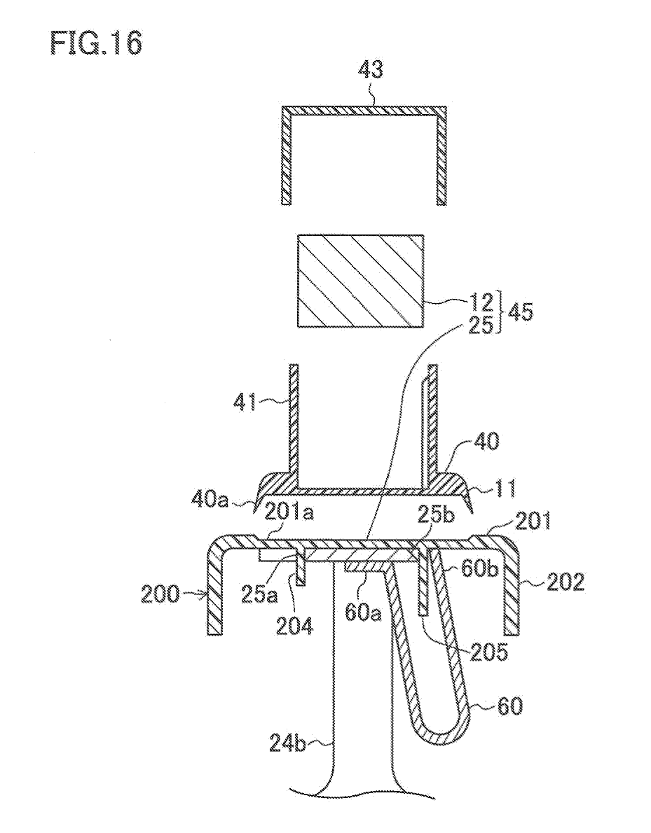

FIG. 14 shows an object holding apparatus 1 of the second embodiment of the present disclosure. The object holding apparatus 1 of the second embodiment is different from the object holding apparatus 1 of the first embodiment in the shape of an object 200 (see FIG. 16), and the corresponding structure of the body 10 and the size of the mask 11. Therefore, the differences from the first embodiment will be described hereinafter in detail.

The object 200 held on the object holding apparatus 1 of the second embodiment includes a round plate 201 and a circumferential wall 202 smaller than those of the object 100 held on the object holding apparatus 1 of the first embodiment. A substantially round recess 201a is formed in a front surface of the round plate 201. The recess 201a is a non-treatment portion where the coating is not performed. The coating is performed on the front surface of the round plate 201 except for the recess 201a, and the surface of the circumferential wall 202.

On a rear surface of the round plate 201, a first rib 204 and a second rib 205 are formed to extend perpendicular to the round plate 201. The first rib 204 and the second rib 205 are substantially parallel to each other. The first rib 204 is shorter than the second rib 205.

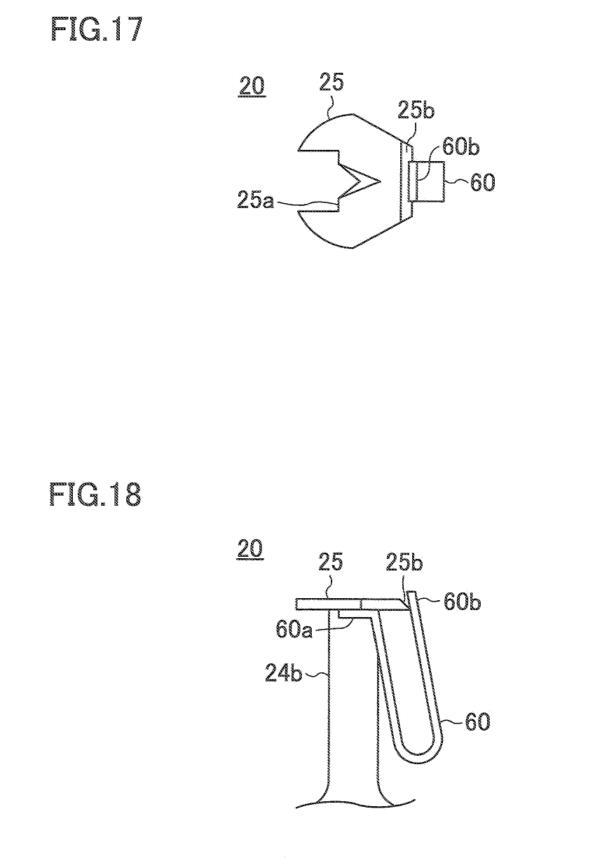

The structure of the object holding apparatus I will be described. A plate 24 of the object fixing member 20 has five flat protrusions 24b as shown in FIG. 15. An object holding plate 25 is attached to each of the flat protrusions 24b. As shown in FIG. 17, each of the object holding plates 25 has a cut 25a. The first rib 204 of the object 200 is inserted in and engages with the cut 25a as shown in FIG. 16.

A flat spring 60 is attached to each of the object holding plates 25. The flat spring 60 is formed by bending a spring steel strip substantially in the shape of letter U. An end of the flat spring 60 is configured as a fixed portion 60a fixed to the object holding plate 25. The fixed portion 60a is formed by bending the end of the flat spring 60 to extend along the object holding plate 25. The flat spring 60 extends from the object holding plate 25 to the proximal end of the flat protrusion 24b, and is curved to extend toward the distal end of the flat protrusion 24b. The distal end 60b of the flat spring 60 is in press contact with the peripheral edge of the object holding plate 25 opposite the cut 25a by spring force. As shown in FIG. 18, the peripheral edge of the object holding plate 25 onto which the distal end 60b of the flat spring 60 is pressed is provided with a tilted surface 25b tapered toward the edge. As shown in FIG. 16, the distal end 60b of the flat spring 60 and the peripheral edge of the object holding plate 25 sandwich the second rib 205 of the object 200. The object holding plate 25 and the flat spring 60 constitute the engagement member according to the present disclosure.

The mask 11 of the second embodiment is formed smaller than the mask 11 of the first embodiment to correspond with the shape of the object 200. The structure of the mask 11 of the second embodiment is the same as that described in the first embodiment.

Coating of the object 200 using the above-described object holding apparatus 1 will be described. First, the object 200 is held on the object holding apparatus 1. In this case, as shown in FIG. 16, the first rib 204 of the object 200 is inserted in the cut 25a of the object holding plate 25, thereby engaging the object holding plate 25 with the object 200. Then, the second rib 205 of the object 200 is inserted between the distal end 60b of the flat spring 60 and the peripheral edge of the object holding plate 25. As a result, the second rib 205 is sandwiched between the distal end 60b of the flat spring 60 and the peripheral edge of the object holding plate 25, thereby engaging the object holding plate 25 and the flat spring 60 with the object 200. Thus, the object 200 is positioned relative to the object holding plate 25.

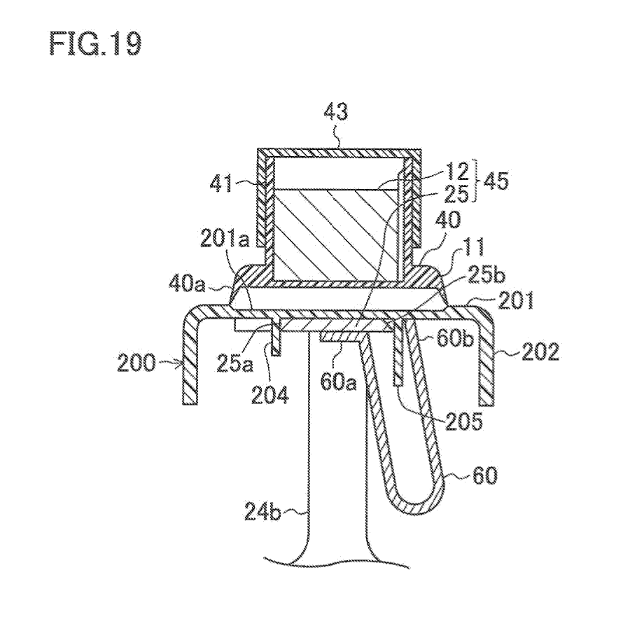

Then, as shown in FIG. 19, the mask 11 is fixed to the object 200 in the same manner as described in the first embodiment, and the coating of the object 200 is performed.

According to the second embodiment described above, like the first embodiment, the object 200 is positioned relative to the body 10 in fixing the mask 11 by the magnetic force. Therefore, the mask 11 can precisely be fixed at the right position, thereby reducing the number of defective products.

Further, the second rib 205 of the object 200 is sandwiched between the distal end 60b of the flat spring 60 and the object holding plate 25. Therefore, the possibility of misalignment of the object 200 can be reduced in a simple manner.

The mask 11 of the first and second embodiments can be reused.

In the first and second embodiments, the objects 100 and 200 are resin products for vehicles. However, the objects 100 and 200 are not limited to those described above.

In the first and second embodiments, the coating of the objects 100 and 200 is described. However, the present disclosure is applicable to other surface treatments, such as sandblasting, shot blasting, shot peening, etc.

In the first and second embodiments, the magnet 12 is fixed to the mask 11. However, the present disclosure is not limited thereto. The magnet 12 may be fixed to the body 10, and the mask 11 may be provided with a magnetic member.

The magnet 12 may be a permanent magnet, or an electromagnet.

The magnet 12 may be embedded in the mask 11. The mask 11 may partially be made of a magnet. Further, a plurality of the magnets 12 may be provided for a single mask 11.

As described above, the disclosed object holding apparatus can be used, for example, for the coating operation.

What is claimed is:

1. An object holding apparatus for holding an object, a portion of which is supposed to be surface treated, the object holding apparatus comprising:
a body to which the object is fixed;
a mask for covering a non-treatment portion of the object; and
a magnetic fixing member for bringing the mask into close contact with the object by magnetic force, wherein
the body includes an engagement member for engaging with the object, thereby positioning the object.

2. The object holding apparatus of claim 1, wherein
the engagement member includes an insertion part formed to be inserted in a portion of the object.

3. The object holding apparatus of claim 2, wherein
the body includes a biasing member for biasing the insertion part in a direction in which the insertion part is inserted in the portion of the object.

4. The object holding apparatus of claim 1, wherein
the engagement member is configured to sandwich a portion of the object.

5. The object holding apparatus of claim 1, wherein
the magnetic fixing member has a magnet detachably attached to the mask, and a magnetic material fixed to the body, and
the mask is fixed by exerting magnetic force of the magnet attached to the mask on the magnetic material of the body.
